(19) United States
(12) Patent Application Publication
(10) Pub. No.: US 2006/0219099 A1
(43) Pub. Date: Oct. 5, 2006

(54) Automatic cooker

(76) Inventor: Yun Pan, ShenZhen City (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/098,482

(22) Filed: Apr. 5, 2005

(51) Int. Cl. A21B 7/00

(52) U.S. Cl. 99/348

(57) ABSTRACT

An automatic cooker includes a lid, a body, a control system, a heating tube, and a heating plate. The lid and the control system are mounted at a top of the body. The heating tube is configured to have a frame-shape and is substantially horizontally provided within an oven chamber of the body at a lower portion thereof, and the heating plate is mounted within the oven chamber at the bottom thereof. The automatic cooker of the present invention is multifunctional, has a stable and simple structure, and can be used to knead breadstuff, steam, fry, cook, stew, boil, or bake food.

### BACKGROUND OF THE INVENTION

1. Field of the Invention

The present invention relates to an automatic cooker, and particularly to an automatic cooker which can be used to knead breadstuff, steam, fry, cook, stew, boil, and bake food.

2. Description of Related Art

Automatic cooker includes micro-wave oven, and automatic bread maker. The micro-wave oven heats food using microwave. Referring to the automatic bread maker, in which a desired menu course is selected from a plurality of bread-making menu courses, after required ingredients being put into a bread vessel, a bread-making process, comprising a kneading step of kneading the ingredients, a fermentation step of fermenting dough, a degassing step of deflating the expanded dough, a shaping-fermentation step of expanding the dough into a shape of the bread, and a baking step of baking the expanded dough, are performed in a sequential manner, thereby automatically making the bread.

U.S. Pat. No. 5,967,020 disclosed an automatic bread maker comprising an oven chamber having a heater, a kneader and a temperature sensor; a bread vessel detachably mounted within the oven chamber, for charging breadstuff; a steam-producing device for producing steam within the oven chamber; and a controller for controlling the steam-producing device wherein a steaming step of steaming dough is effected before a baking step of baking the dough. This automatic bread maker can produce steam bread to make bagel bread. A heater of this automatic is a heating tube, and is provided within the oven chamber at a lower portion thereof in surrounding relation to the bread casing. A water storage tray with a recess being formed in a peripheral edge of a lower surface of the same so that the water storage tray can be placed on the heating tube, is heated to produce steam. However, an extra water storage tray is necessary for producing steam using this device, thus the structure is relatively complex and not convenient in use. Another structure of the heater is that a recess, defining a water storage portion for holding steam-producing water, is formed in a bottom of an oven chamber at an outer peripheral portion thereof, and the heating tube is provided in this water storage portion to form a steam-producing portion. However, the heating tube directly contact with water when steam is being produced, thus the heater easily rust.

U.S. Pat. No. 5,937,740 also disclosed an automatic bread maker with a heating tube being provided within the oven chamber at a lower portion thereof in surrounding relation to the bread casing. A steamplate forming groove for containing water is directly placed on the heating tube for producing steam. However, as described above, a water container is necessary for producing steam. Furthermore, the steamplate cannot stably stay on the heating tube.

Additionally, the traditional automatic bread maker has only one heating tube to heat within the oven chamber at a lower portion thereof in surrounding relation to the bread casing, the heating area is relatively small and heating effective is low. Furthermore, the traditional automatic bread maker just has one more function for producing steam.

Therefore, an improved automatic cooker is desired which overcomes the disadvantages of the prior art.

### SUMMARY OF THE INVENTION

A main object of the present invention is to provide an multifunctional automatic cooker which has a stable and simple structure with an adjustable and effective heating means, and can be used to knead breadstuff, steam, fry, cook, stew, boil, and bake food.

An automatic cooker comprises a lid, a body, a control system, and a heating means. The heating means comprises a heating tube and a heating plate. The lid and the control system are mounted at a top of the body, the heating tube is configured to have a frame-shape and is substantially horizontally provided within an oven chamber of the body at a lower portion thereof, and the heating plate is mounted within the oven chamber at a bottom thereof.

Other objects, advantages and novel features of the invention will become more apparent from the following detailed description of a preferred embodiment thereof when taken in conjunction with the accompanying drawings, wherein:

### BRIEF DESCRIPTION OF THE DRAWINGS

FIG. 1 is a perspective view of an automatic cooker in accordance with a preferred embodiment of the present invention;

FIG. 2 is a explode, perspective view of FIG. 1;

FIG. 3 is a perspective view of a heating element in accordance with a preferred embodiment of the present invention;

FIG. 4 is another view of the heating element of FIG. 3;

FIG. 5 is a view showing a condition of the automatic cooker in accordance with a preferred embodiment of the present invention;

FIG. 6 is a view showing another condition of the automatic cooker in accordance with a preferred embodiment of the present invention;

FIG. 7 is a view showing a third condition of the automatic cooker in accordance with a preferred embodiment of the present invention; and

FIG. 8 is a block diagram showing a control system of the automatic cooker.

### DETAILED DESCRIPTION OF THE INVENTION

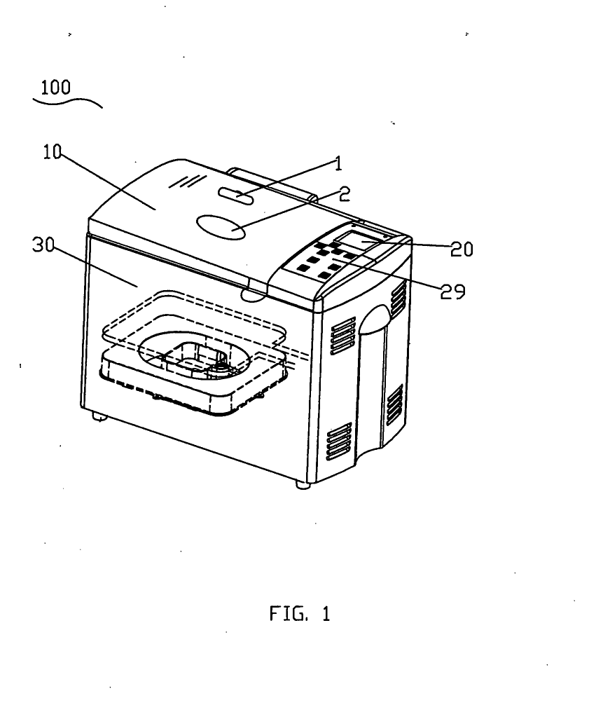

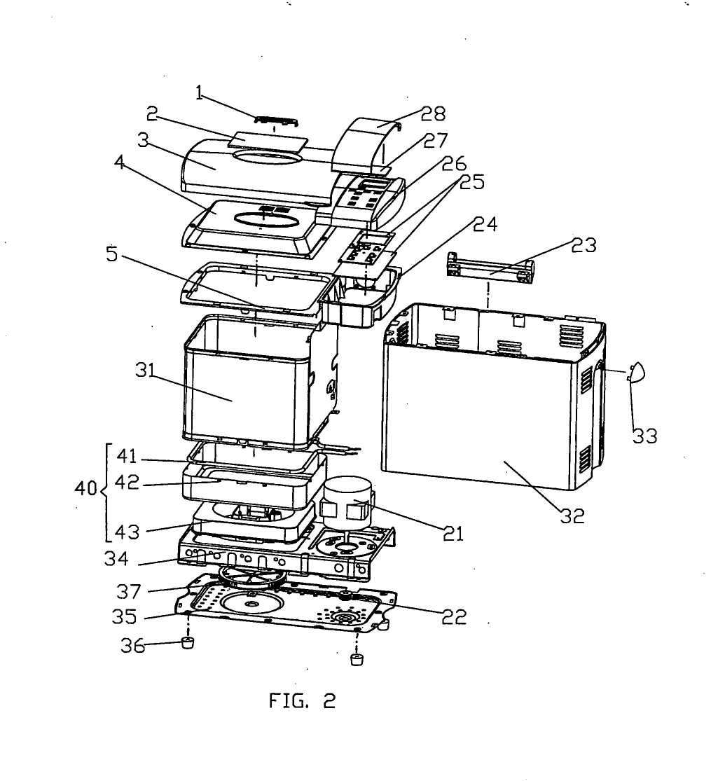

Referring now to the drawings in detail, FIG. 1 shows an automatic cooker 100 in accordance with a preferred embodiment of the present invention. The cooker 100 comprises a lid 10, a body 30, a control device 20, and a heating means 40 (as shown in FIG. 2).

Referring to FIG. 2 together, the lid 10 includes a hot exhausting cover 1, transparent cover 2, upper cover 3, upper panel 4, and adiabatic frame 5. Wherein, the upper cover 3 and upper panel 4 define a plurality of vents and an opening for respectively receiving the hot exhausting cover 1 and transparent cover 2 to form a hot exhausting passage and a transparent window. The lid 10 is reversibly connected with the body 30 using a stand 23, so that the lid 10 is openably and closably mounted at an upper side of the body 30.

The body 30 has a housing 32 being provided with a plurality of vents on walls thereof, an oven chamber 31, handles 33, big base 34, hot exhausting soleplate 35, and foot slips 36. The oven chamber 31 is mounted in the housing 32, and the handles 33 are fixed on sidewalls of the same. The big base 34 and hot exhausting soleplate 35 are assembled into a bottom base to cover the body 30 on the bottom with four foot slips 36 supporting. A bread vessel, fryer, basket or tray can be detachably mounted within the oven chamber 31.

The control device 20 includes a PCB board 25, a cabinet body 26, an LCD display 27, a motor 21, a big gear 37, and a small gear 22. The PCB board 25, cabinet body 26, LCD display 27 are mounted in a lower cover 24 to form a control cabinet 29 with an upper cover 28 thereon. The control cabinet 29 and the lid 10 are parallelly mounted on the body 30, and the motor 21 is placed within the housing 32 being arrayed with the oven chamber 32. The gears 22, 37 are connected by a belt (not shown), and being driven by the motor 21 in order to drive kneading blade. The PCB board 25 comprises microcomputer and a memory thereof for automatic control and storing executive programs.

The heating means 40 includes a heating tube 41 and heating plate 43. The heating tube 41 is configured to have a frame-shape and is substantially horizontally provided within the oven chamber 32 at a lower portion thereof in surrounding relation to the bread vessel. The heating plate 43 is mounted at the bottom of the oven chamber 31. An adiabatic base 42 is set on the inner surface of the oven chamber 31, and between the heating tube 41 and the heating plate 43.

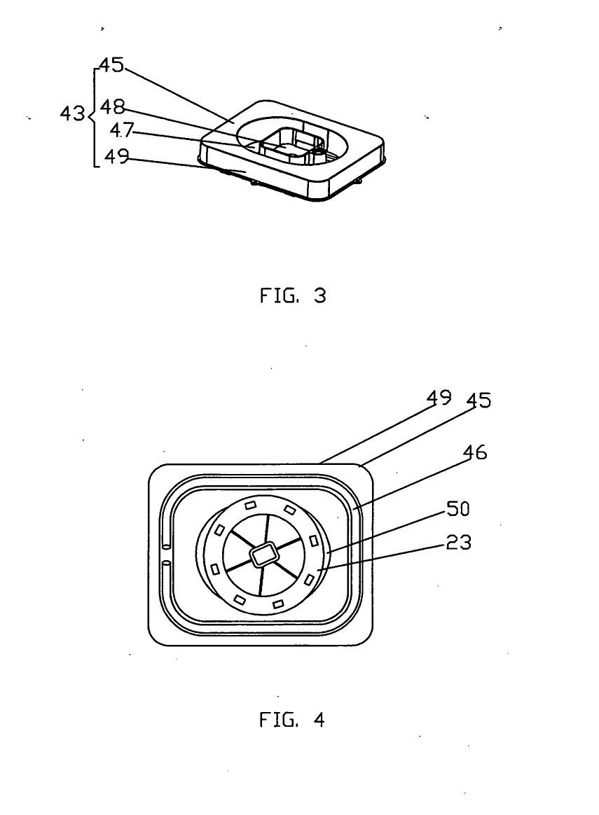

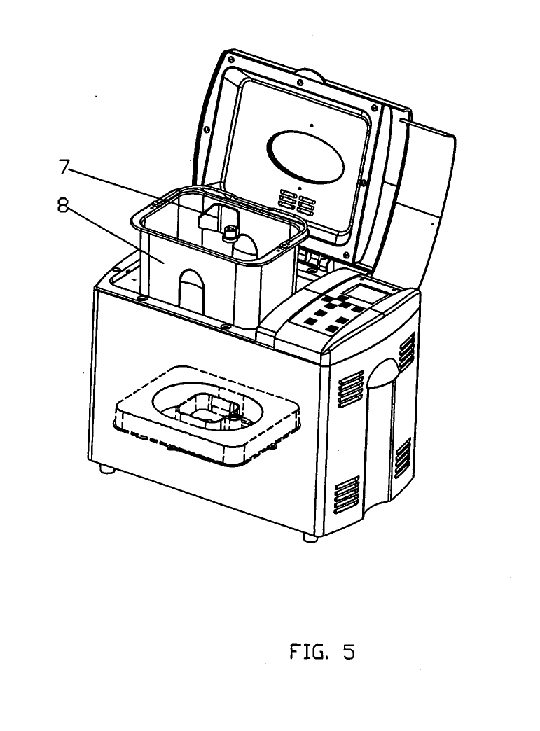

Referring to FIGS. 3 and 4, the heating plate 43, being configured, but is not to be limited to a flat and quadrangular shape, includes a casing 45 and a heating tube 46. The casing 45, being made of aluminum having good heat-reflecting properties and erosion resistant, defines a water storage portion 47 in a front surface. The water storage portion 47 is substantially a recess. A support portion 48 is formed at a center of the recess for mounting the kneading blade. The heating tube 46 in a frame-shape is mounted on the back of the casing 45 in surrounding relation to a projecting back bottom 50 of the water storage portion 47. The big gear 37 is mounted on the bottom 50 to couple with the kneading blade. The heating tube 46 heats the casing 45, thus the whole heating plate 43 forms an effective heat source with more heat-transferring area. The water storage portion 47 holding water therein can be heated to produce steam while the heating tube 46 does not directly contact with water, which is advantageous to protect the heating tube 46 from rusting.

It is understood that some baffles can be set in the recess so that the water storage portion 47 is divided into a plurality of cells.

The body 30 also has a temperature sensor (not shown) mounted therein.

The heating tube 41, 46, and the control device 20 are electrically connected to the PCB board 25.

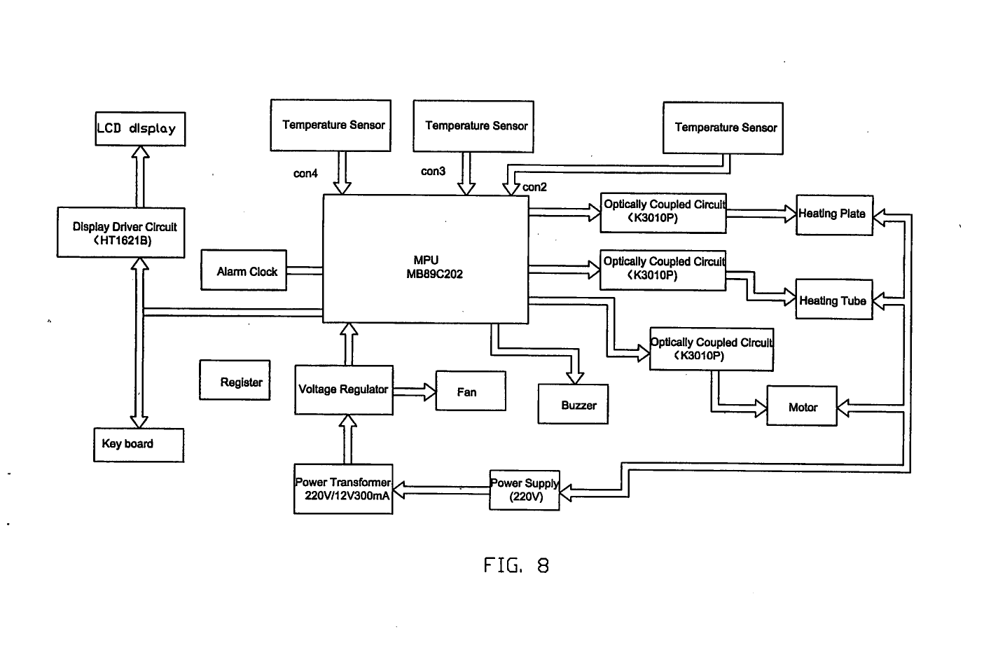

Referring to FIG. 8, the block diagram of the control system comprises a Micro Processing Unit (MPU). The MPU has a chip of MB89C202. A power supply at a voltage of 220V is transformed to a DC voltage of 6V through a power transformer and a voltage regulator, and supplies to the MPU. A fan is set to the voltage regulator for cooling. An LCD display for displaying time, temperature, menu, or steps, is connected to the MPU through a display driver circuit. A keyboard is also connected to the display driver circuit. A register is used for storing data. Three temperature sensors, which are respectively used to indicate the temperatures of the sidewall of the oven chamber, inside and outside of the heating plate 43, are respectively connected to CON2 to CON4. The MPU is respectively connected to heating plate 43, heating tube 40, and motor 21 through an optically coupled circuit.

The automatic cooker 100 of the present invention has two kinds of functional groups: one is fixed program group, the other is hand-control program group. Wherein, in the fixed program group, eighteen fixed program courses are available. Users can also set different functions according to their desire.

Referring to the eighteen fixed program courses, for instance, the first to the fourth program courses are used for roasting, cooking, or frying; the fifth program course is used for making candy; the sixth to the fourteenth program courses are used for kneading; the eighteenth is used to making jam, by means of starting the heating tube 41 or the heating plate 43, or both of them at the same time.

The automatic cooker 100 in the present invention can be used to make steamed bread, steamed stuffed bun, boiled dumpling, meat, or vegetable by means of steaming, used to bake bread, or dim sum, roast chicken, fish, or duck; used to fry food; used to boil food; used to knead, or stew. Various delicious Chinese food or western food can be made using the automatic cooker 100.

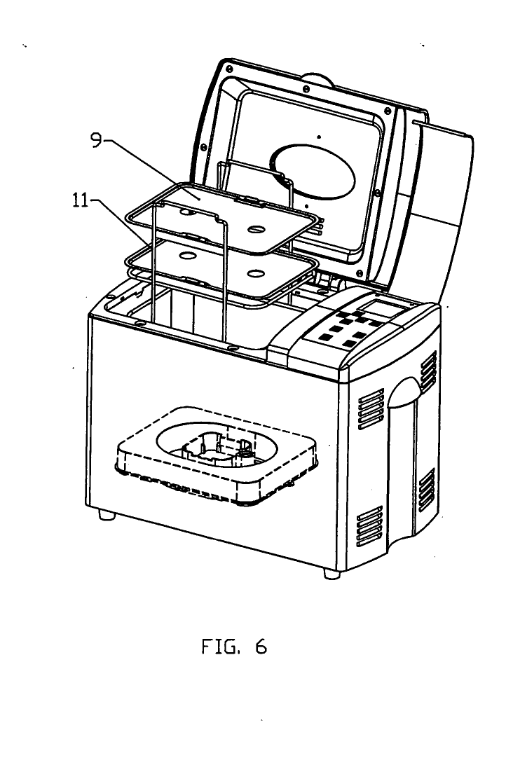

FIG. 5 shows the automatic cooker 100 being used for dough kneading. A bread vessel 8 is mounted in the oven chamber 31, and kneading blade 7 is fixed at the support portion 48 of the heating plate 43. The ingredients for bread are charged into the bread vessel 8, a kneading menu course is selected, and then the dough kneading will be automatically performed in a predetermined time.

FIG. 6 shows the automatic cooker 100 being used to steam food, such as bread. Water is put into the water storage portion 47 of the heating plate 43, trays 9 with bread dough being placed thereon are supported on basket 11, and then fixed onto the heating plate 43. Steaming course is selected to active the heating plate 43 for producing steam. If the water storage portion 47 holds no water, but a vessel being charged water is mounted within the oven chamber 31 on the heating plate 43, and the basket 11 and trays 9 are placed in the vessel, steam can also be produced. Herein, the heating tube 41 can also be activated to heat the vessel.

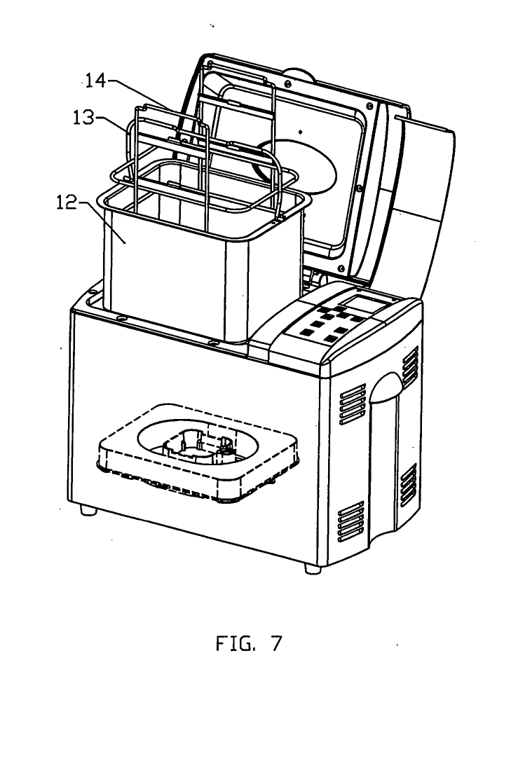

FIG. 7 shows the automatic cooker 100 being used to fry food. Herein, basket 14 is placed within a deep fryer tank 12 (being provided with handle 13), then the tank 12 is placed into the oven chamber 31 and supported on the heating plate 43, while the heating tube 41 surrounding relation to the tank 12. Foods are placed on the basket 14, oil is poured into the tank 12, frying menu course is selected, and then frying can be automatically completed. The heating tube 41 is selective to heat.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. An automatic cooker comprising:
a lid;
a body;
a control system; and
a heating means;
wherein the lid is mounted at a top of the body, the heating means comprises a heating tube and a heating plate, the heating tube is configured to have a frame-shape and is substantially horizontally provided within an oven chamber of the body at a lower portion thereof, and the heating plate is mounted within the oven chamber at a bottom thereof.

2. The automatic cooker as claimed in claim 1, wherein said heating plate comprises a casing and a heating tube, the casing defines a water storage portion in a front surface thereof, and the heating tube of the heating plate is mounted on a back of the casing.

3. The automatic cooker as claimed in claim 2, wherein said heating tube of the heating plate is in a frame-shape, and surrounding relation to a projecting back bottom of the water storage portion.

4. The automatic cooker as claimed in claim 3, wherein said water storage portion is substantially a recess, and a support portion is formed at a center of the recess for mounting kneading blade.

5. The automatic cooker as claimed in claim 4, wherein a plurality of baffles are set in the recess so that the water storage portion is divided into a plurality of cells.

6. The automatic cooker as claimed in claim 4, wherein a big gear is mounted on the back bottom of the water storage portion to couple with the kneading blade.

7. The automatic cooker as claimed in claim 2, wherein said casing is made of aluminum.

8. The automatic cooker as claimed in claim 3, wherein said heating plate is configured to have a flat and quadrangular shape.

9. The automatic cooker as claimed in claim 2, wherein an adiabatic base is set between the heating tube and the heating plate.

10. The automatic cooker as claimed in claim 1, wherein a plurality of hot exhausting passages is defined in the lid and the body of the automatic cooker.

11. The automatic cooker as claimed in claim 1, wherein a bread vessel, trays and basket, or fryer tank, is placed in the oven chamber of the automatic cooker for making steamed bread, steamed stuffed bun, boiled dumpling, meat, or vegetable by means of steaming, for baking bread, or dim sum, roast chicken, fish, or duck; for frying food; for boiling food; or for kneading, or stewing.

12. The automatic cooker as claimed in claim 11, wherein said heating tube within the oven chamber is in surrounding relation to the bread vessel, basket, or fryer tank.

13. The automatic cooker as claimed in claim 1, wherein said control system comprises a upper cover, an LCD display, a body, a PCB board, and a lower cover, the PCB board and LCD display are mounted on the body of the control system, and together being housed using the upper cover and the lower cover thereof.

14. The automatic cooker as claimed in claim 13, wherein said PCB board comprises microcomputer and a memory thereof for automatic control and storing executive programs.

15. The automatic cooker as claimed in claim 14, wherein a small gear driven by a motor is connected with a big gear using a belt for driving kneading blade.

16. An automatic cooker comprising:
a body;
a lid openably and closably mounted on the body;
a control system for controlling operations of the automatic cooker; and
a heating means;
wherein the heating means comprises a heating tube and a heating plate, the heating tube is configured to have a frame-shape and is provided within an oven chamber of the body at a lower portion thereof, and the heating plate is mounted at a bottom of the oven chamber and defines a water storage portion in a front surface thereof.

17. The automatic cooker as claimed in claim 16, wherein said heating plate comprises a casing and a heating tube, and the heating tube of the heating plate is mounted on a back of the casing.

18. The automatic cooker as claimed in claim 17, wherein said heating tube of the heating plate is in a frame-shape, and surrounding relation to a projecting back bottom of the water storage portion.
